(19) United States
(12) Patent Application Publication
(10) Pub. No.: US 2003/0044180 A1
(43) Pub. Date: Mar. 6, 2003

(54) Wrist mounted camera support

(76) Inventor: Arne Lindberg, Santa Cruz, CA (US)

Correspondence Address: Arne Lindberg, 4725 OPAL CLIFF DR., SANTA CRUZ, CA, 95062, US

(21) Appl. No.: 09/945,216

(22) Filed: Sep. 4, 2001

(51) Int. Cl. G03B 17/00

(52) U.S. Cl. 396/420

(57) ABSTRACT

Wrist Mounted Camera Support with a camera enclosure made of resilient material such as lycra covered neoprene, the camera enclosure having a plurality of arm retaining straps integral to the enclosure, the retaining straps having fastening such as hook and loop type fasteners, and the camera enclosure having cut out openings allowing a camera lens, view finder, winding and photo taking button to be easily accessable to the user. A preferred embodiment includes wherein said retaining straps wrap around the users forearm at the wrist area.

### BACKGROUND OF THE INVENTION

This invention relates generally to the field of camera accessories, and more particularly to a wrist mounted camera support.

In the process of taking pictures with a camera it sometimes becomes necessary for the user to make use of a camera holding means that help support the camera under certain circumstances.

Such supports that are well known include tripod type stands and smaller handles or posts attached to the underside of the camera.

Under water photography has become popular in recent years, especially with the introduction of inexpensive, one time use, waterproof cameras such as Kodak's “Max Sport” camera. During the process of swimming it is necessary for a person to use both hands and arms to help propel him or herself through the water. Carrying a camera becomes problematic because it forces the user to relinquish one hand to the job of carrying the camera. The camera may be carried in a pocket on the user's swimming outfit, or may be retained by means of a lanyard that attachs to the camera at one end and wraps around the users wrist or neck. unfortunately, these retaining means tend to be problematic in that the user must pull the camera out of a pocket or must retrieve that camera from its lanyard and position the camera for taking a photo, a time consuming process that may cause the user to be too slow in taking a photo of a moving object such as a fish. Additionally, there may be other applications for a wrist mounted camera holder under other conditions such as during sports activities or other applications where the user wants to use a camera for quick photo opportunities while having both hands free when not using the camera.

### SUMMARY OF THE INVENTION

The primary object of the invention is to provide a wrist mounted camera support that allows the user to retain a camera near the wrist portion of his or her arm.

Another object of the invention is to provide a camera support that removably attaches to a persons arm thereby allowing the user to have both hands free during swimming or other activities.

Another object of the invention is to provide a camera support that is water resistant and is designed to receive camera that is water resistant.

A further object of the invention is to provide a camera support that receive camera's that have control components on their top surface, such as “Kodak Max Sport”, Fugi “Quick Snap” and Sony “Ciber Shot”.

Other objects and advantages of the present invention will become apparent from the following descriptions, taken in connection with the accompanying drawings, wherein, by way of illustration and example, an embodiment of the present invention is disclosed.

Wrist Mounted Camera Support comprising: a camera enclosure made of resilient material such as lycra covered neoprene, said camera enclosure having a plurality of arm retaining straps integral to said enclosure, said retaining straps having fastening means such as hook and loop type fasteners, and said camera enclosure having cut out openings allowing a camera lens, viewfinder, winding and photo taking button to be easily accessable to the user.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of a person taking a photo using a camera that is retained by the camera holder of the present invention.

FIG. 2 is a front view of the camera holder of the present invention

FIG. 3 is a rear view of the camera holder of the present invention.

FIG. 4 is a perspective view showing the insertion of a camera into the camera holder of the present invention.

FIG. 5 is a top view of the present invention.

FIG. 6 is a side view of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

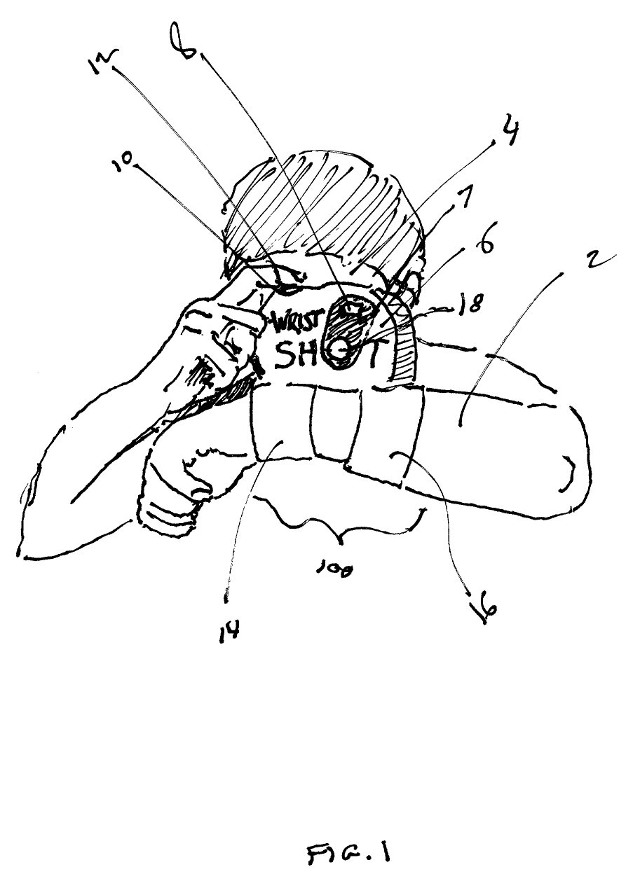

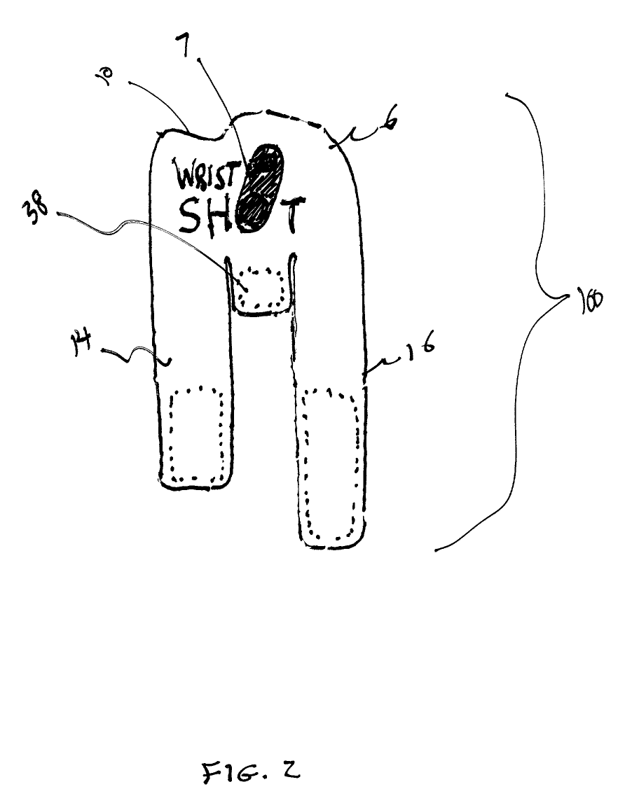

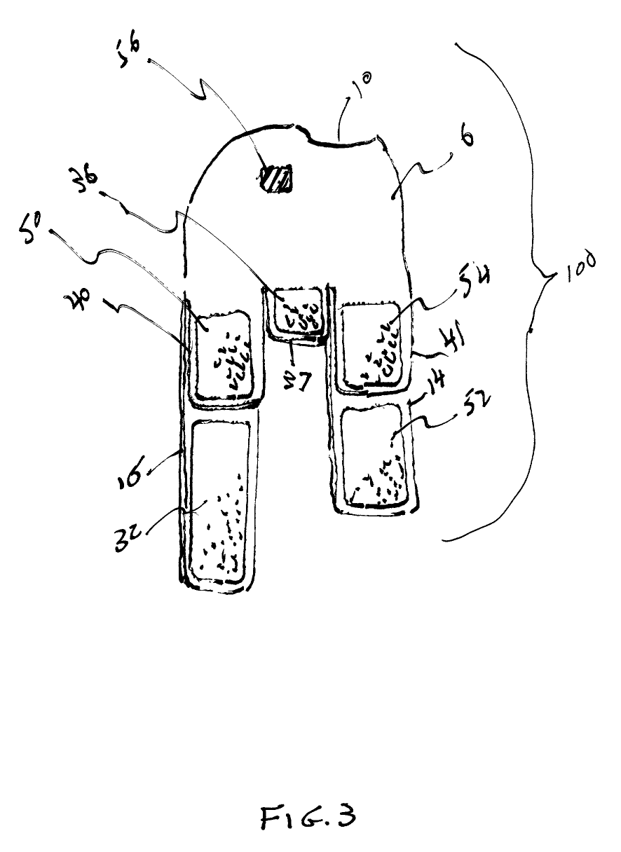

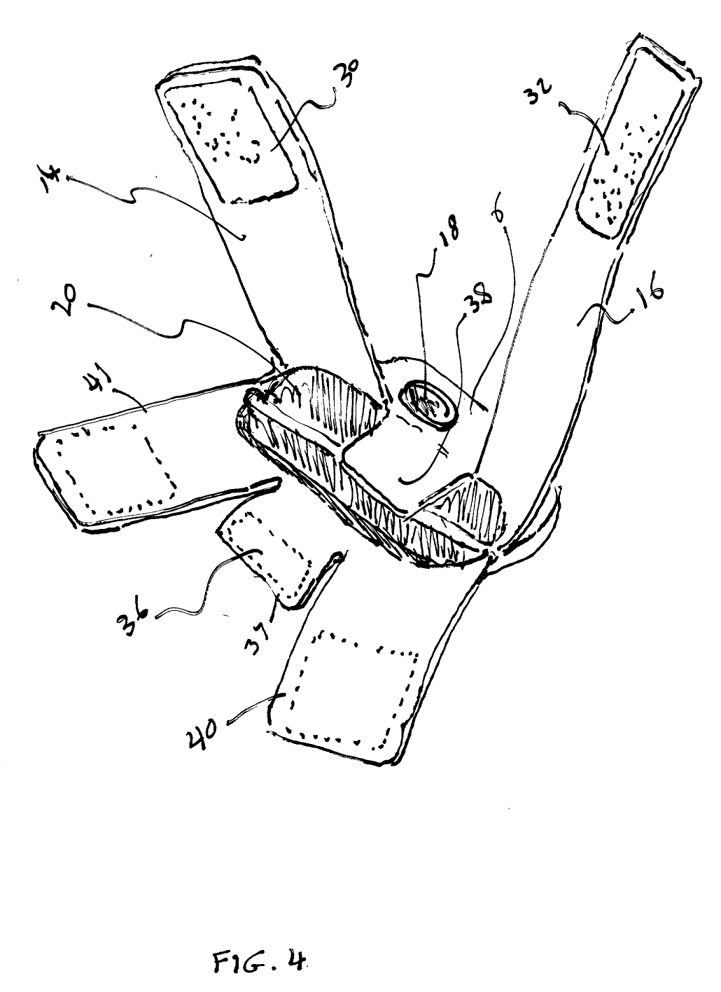

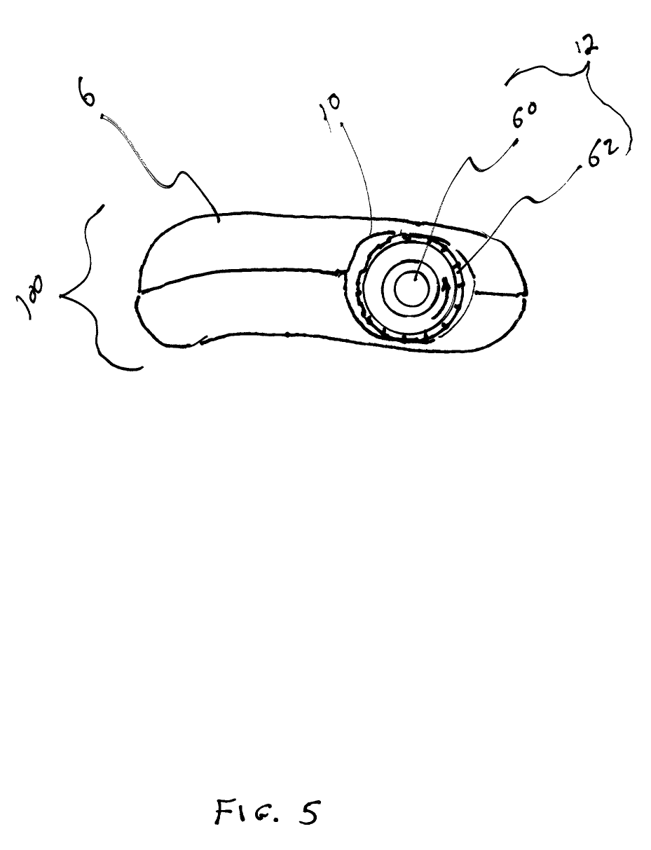

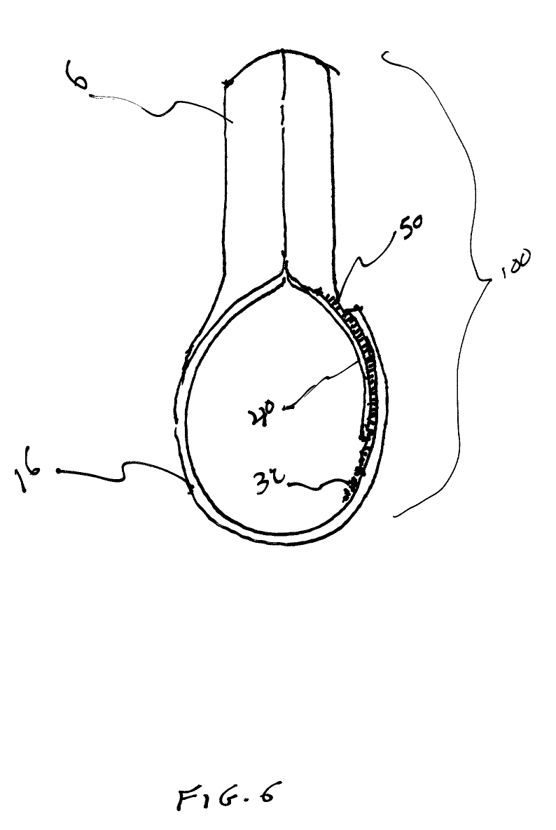

Referring now to FIG. 1 we see a perspective view of a person using the camera holder of the present invention 100. The camera holder 100 is removably retained on the users forearm 2 by means of a pair of straps 14, 16. The camera enclosure 6 has an opening 7 in the front allowing the lens 18 and view finder 8 to be visible. An additional opening 10 at the top of enclosure 6 exposes the winding knob and photo taking button 12. The enclosure is designed to receive an underwater water camera or other types of cameras. Cameras such as Kodak's “Max Sport” and Fugi's “Quick Snap” are underwater cameras and have control components that are located on the top surface of the camera so that the user can have easy access to them. Other cameras may exist and still others may be manufactured in the future that fit the above description. The camera enclosure 6 can be modified and manufactured to accept new models. The enclosure 6 and integral retaining straps 14, 16 are made of lycra covered neoprene in the preferred embodiment, but may be made of other resilient materials. It is clear from the FIG. 1 illustration that a person can have his or her hands free to swim or pursue other activities, while having a camera readily available for photographing moving objects such as swimming fish or the like. FIG. 2 is a front view of the present invention 100 showing straps 14, 16 that are used to wrap around the users forearm at the wrist area. Strap 38 is used to retain the camera after it is inserted into the underside of the enclosure 6. FIG. 3 is a rear view of the present invention 100. In this view one can see shorter arm retaining straps 40, 41 and camera retaining strap 36. The straps have hook and loop type fastening devices sewn onto them. Loop type devices 32, 52 are sewn onto straps 16 and 14 as well as camera retaining strap 38. Hook type devices 50, 54, 36 are sewn onto straps 40, 41, 37. In this way a person can fasten the camera support 100 onto his or her arm. An additional view of the fastening means can be seen in FIG. 6. FIG. 4 shows a perspective view showing the camera 20 inserted into the enclosure 6. Straps 36, 37 can fold over the underside of the camera 20 to retain it. FIG. 5 shows a top view of the present invention 100. Cutout opening 10 exposes winding knob 62 and photo taking button 62 which has previously been referred to as numeral 12.

In the above described and illustrated way, the present invention provides a way for a person to mount a camera on his or her wrist area thereby leaving the users hands free to do other activities such as swimming and yet, storing the camera in a location that allows the user to take pictures quickly when so desired.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Wrist Mounted Camera Support comprising:
a camera enclosure made of resilient material such as lycra covered neoprene;
said camera enclosure having a plurality of arm retaining straps integral to said enclosure;
said retaining straps having fastening means such as hook and loop type fasteners; and
said camera enclosure having cut out openings allowing a camera lens, view finder, winding and photo taking button to be easily accessible to the user.

2. Wrist Mounted Camera Support as claimed in claim 1 wherein said retaining straps wrap around the users forearm at the wrist area.
